(19) United States
(12) Patent Application Publication
(10) Pub. No.: US 2026/0014719 A1
(43) Pub. Date: Jan. 15, 2026

(54) RAZOR CARTRIDGE AND RAZOR ASSEMBLY COMPRISING SAME

(71) Applicant: DORCO CO., LTD., Seoul (KR)

(72) Inventors: Sung Hee SON, Seoul (KR); Jun Soo CHANG, Seoul (KR); Jong Jin JEONG, Seoul (KR)

(21) Appl. No.: 19/337,001

(22) Filed: Sep. 23, 2025

Related U.S. Application Data
(63) Continuation of application No. PCT/KR2024/003977, filed on Mar. 28, 2024.

(30) Foreign Application Priority Data
Mar. 28, 2023 (KR) 10-2023-0040806
May 26, 2023 (KR) 10-2023-0068696
Jul. 21, 2023 (KR) 10-2023-0095160

(51) Int. Cl. B26B 21/52; B26B 21/22; B26B 21/40

(52) U.S. Cl. CPC B26B 21/521; B26B 21/225; B26B 21/4018

(57) ABSTRACT

A razor cartridge to couple with a razor handle may include at least one blade formed with a cutting edge. The razor cartridge may also include a blade housing accommodating the blade in a longitudinal direction to expose the cutting edge toward a front upper side. The blade housing may include a connector disposed on a lower surface of the blade housing and forming an accommodating space in which a connecting arm of the razor handle is at least partially accommodated. The blade housing may also include a docking portion forming an inlet of the accommodating space on the lower surface of the blade housing and including a downward slope in an opposite direction to a direction where the connecting arm enters the accommodating space.

### CROSS REFERENCE TO RELATED APPLICATIONS

This is a continuation application of International Patent Application No. PCT/KR2024/003977 filed on Mar. 28, 2024, which claims priority to Korean patent application No. 10-2023-0040806 filed on Mar. 28, 2023, Korean patent application No. 10-2023-0068696 filed on May 26, 2023, and Korean patent application No. 10-2023-0095160 filed on Jul. 21, 2023, contents of each of which are incorporated herein by reference in their entireties.

### BACKGROUND

### Technical Field

The disclosure relates to a razor cartridge and a razor assembly including the same, and more particularly to a razor cartridge, to which a blade housing and a razor handle are detachably coupled, and a razor assembly including the same.

### Description of Related Technology

In general, a razor refers to a product for cutting body hair such as fuzz and beard on a face or body, and includes a razor handle for gripping, and a razor cartridge with a blade that comes into contact with skin to have a shave.

### SUMMARY

One aspect is a razor cartridge and a razor assembly including the same, in which the razor cartridge is not separated from a razor handle when shaving, but easily replaced.

The aspects of the disclosure are not limited to those described herein, and other aspects not mentioned herein may become apparent to those skilled in the art from the following description.

Another aspect is a razor cartridge to couple with a razor handle that includes: at least one blade formed with a cutting edge; and a blade housing accommodating the blade in a longitudinal direction to expose the cutting edge toward a front upper side, wherein the blade housing includes: a connector disposed on a lower surface of the blade housing and forming an accommodating space in which a connecting arm of the razor handle is at least partially accommodated, and a docking portion forming an inlet of the accommodating space on the lower surface of the blade housing and including a downward slope in an opposite direction to a direction where the connecting arm enters the accommodating space.

Other details of the disclosure are included in the detailed description and the accompanying drawings.

According to the embodiments of the disclosure, the effects are at least as follows.

According to the disclosure, a razor cartridge is not easily separated from a razor handle, so that a user can shave safely without being cut by a blade when shaving.

According to the disclosure, a razor cartridge has a structure to be easily replaced, so that a user can easily replace the razor cartridge without much effort.

The effects of the disclosure are not limited to those described above, and various other effects are included in the foregoing description.

### BRIEF DESCRIPTION OF THE DRAWINGS

FIG. 1 is a perspective view illustrating a razor cartridge according to an embodiment of the disclosure and a razor assembly according to another embodiment of and the disclosure.

FIG. 2 is a bottom view illustrating that a razor cartridge according an embodiment of the disclosure is coupled to a connecting arm of a razor handle.

FIG. 3 is a bottom view of the razor cartridge of FIG. 2.

FIG. 4 is a perspective view of a blade housing of FIG. 2.

FIG. 5 is a bottom view illustrating that the connecting arm of FIG. 2 is accommodated in a connector.

FIG. 6 is a lateral cross-sectional view illustrating that the connecting arm of FIG. 2 is accommodated in the connector.

FIG. 7 is a perspective view of an area A of FIG. 3.

FIG. 8 is a perspective view of an area B of FIG. 3.

FIG. 9 is a bottom view of a blade housing of FIG. 2.

FIG. 10 is a plan view of a blade housing of FIG. 2.

FIG. 11 is a plan view of the razor cartridge of FIG. 2.

FIG. 12 is a cross-sectional view taken along the line XII-XII′ of FIG. 2.

FIG. 13 is an enlarged view of an area C of FIG. 12.

FIG. 14 is an enlarged view of an area D of FIG. 12.

### DETAILED DESCRIPTION

The razor handle is formed with a coupling portion to couple with the razor cartridge, and the razor cartridge is formed with a connector to couple with the coupling portion. The coupling portion of the razor handle and the connector of the razor cartridge may be detachably coupled in various coupling ways such as latch coupling, hook coupling, snap-fit coupling, boss coupling, and magnet coupling.

The razor cartridge needs to be replaced periodically for hygienic use. Various methods are used for coupling the razor cartridge and the razor handle, but the coupling between the razor handle and the razor cartridge is generally strong to prevent injuries such as cuts caused by the blade when shaving.

The strong coupling between the razor handle and the razor cartridge makes it difficult for a user to replace the razor cartridge. The reason is because the stronger the coupling between the razor cartridge and the razor handle, the stronger the force is required to separate the razor cartridge and the razor handle.

When a user attempts to replace the razor cartridge and the razor handle with a strong force, the razor cartridge is likely to slip from his/her hand and thus the user may be injured with the sharp blade.

For safe and hygienic use of the razor, there is a need for a razor that maintains proper coupling between the razor handle and the razor cartridge and makes it easy to replace the razor cartridge.

The advantages and characteristics of the disclosure and a method for achieving the advantages and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Below, a razor cartridge according to an embodiment of the disclosure and a razor assembly according to another embodiment of the disclosure will be described with reference to the accompanying drawings. In the drawings, a longitudinal direction, in which a blade extends is parallel to an x-axis, a transverse direction is perpendicular to the longitudinal direction and parallel to a y-axis, a front direction of front and rear directions is a negative y-axial direction in which the razor comes into contact with a user's skin first when stroking, and a rear direction is a positive y-axial direction in which the razor comes into contact with the user's skin later when stroking.

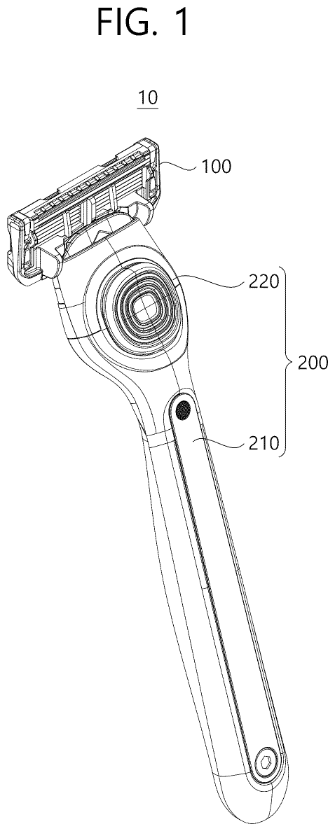

FIG. 1 is a perspective view illustrating a razor cartridge according to an embodiment of the disclosure and a razor assembly according to another embodiment of and the disclosure.

Referring to FIG. 1, a razor cartridge 100 is detachably coupled to a razor handle 200, comes into direct contact with a user's skin, and cuts body hair. The razor cartridge 100 may be detachably coupled to a coupling portion 222 of the razor handle 200 (to be described later).

A razor assembly 10 includes the razor cartridge 100, and the razor handle 200 to which the razor cartridge 100 is pivotally coupled. The razor cartridge 100 will be described first, and the razor assembly 10 will be then described.

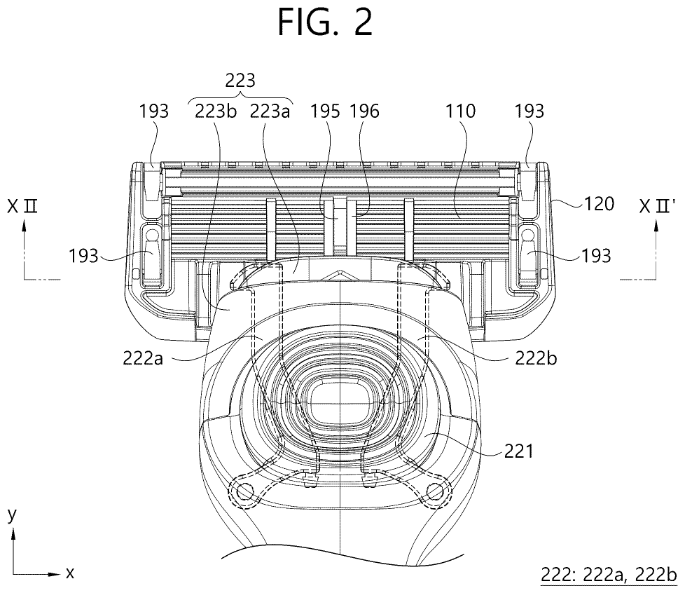

FIG. 2 is a bottom view illustrating that a razor cartridge according an embodiment of the disclosure is coupled to a connecting arm of a razor handle.

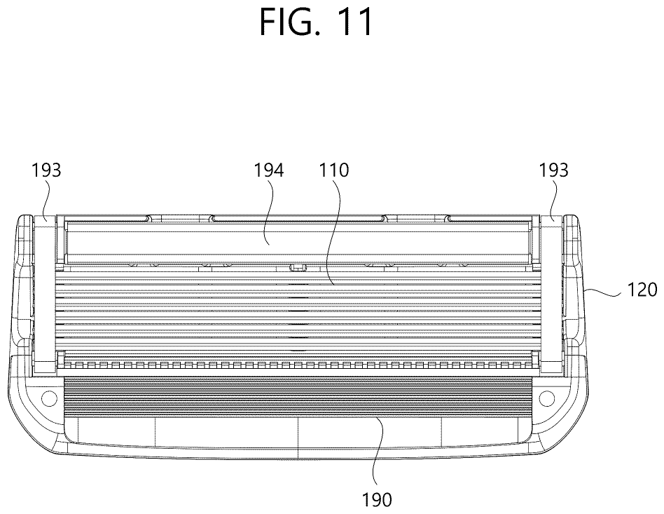

Referring to FIG. 2, the razor cartridge 100 includes a blade 110, a blade housing 120, a guard 190 (see FIG. 11), a clip 193, a cap 194 (see FIG. 11), and a cam surface 195. The razor cartridge 100 may be detachably coupled to connecting arms 222a and 222b of the coupling portion 222 (to be described later).

The razor cartridge 100 may be pivotally supported within a certain angle range with respect to a fixed axis or an axis moving within a certain range. The razor cartridge 100 may be supported by a plunger 223a of the razor handle 200. The pivot axis of the razor cartridge 100 may refer to an axis passing through a first connector 131 and a second connector 132 (to be described later).

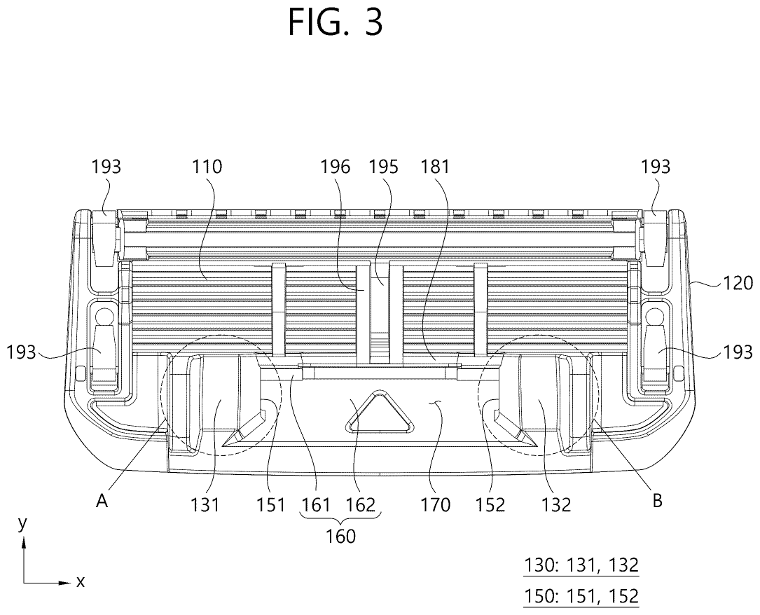

FIG. 3 is a bottom view of the razor cartridge of FIG. 2.

Referring to FIG. 3, the blade 110 is exposed to a shaving plane to cut a user's body hair, and may be made of a rigid material such as steel. The blade 110 may be accommodated in the blade housing 120 forming the body of the razor cartridge 100 as disposed in the longitudinal direction. The cutting edge of the blade 110 may be exposed to the shaving plane to cut a user's body hair. A plurality of blades 110 may be disposed being spaced apart from each other.

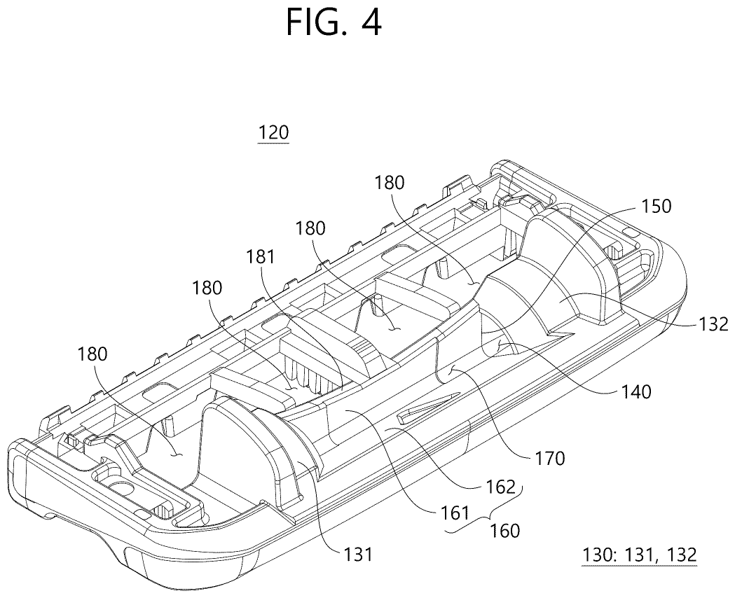

FIG. 4 is a perspective view of a blade housing of FIG. 2.

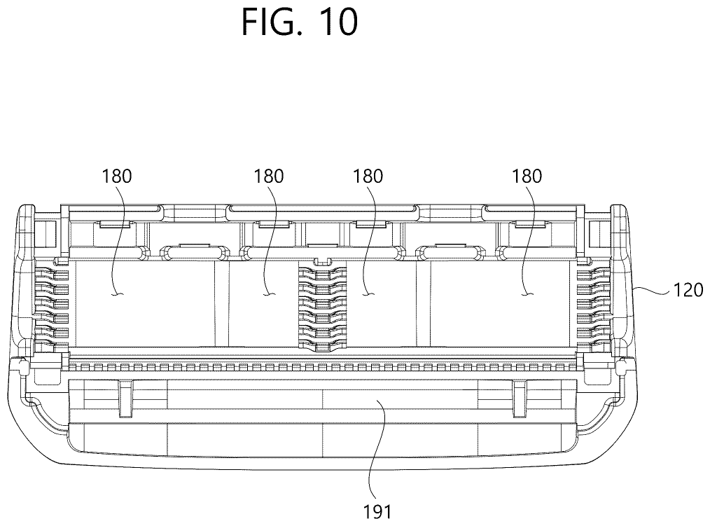

Referring to FIGS. 3 and 4, the blade housing 120 may form the body of the razor cartridge 100. The blade housing 120 may accommodate the blade 110 in the longitudinal direction. The blade housing 120 may include a connector 130, a docking portion 150, an entry portion 160, a rinsing opening 180, a rinsing frame 181, and a guard seating portion 191 (see FIG. 10).

The connector 130 is detachably coupled to the razor handle 200, is disposed on the lower surface of the blade housing 120, and accommodates the connecting arms 222a and 222b of the coupling portion 222 (to be described later). The connector 130 may be coupled to or integrally formed with the lower surface of the blade housing 120.

The connector 130 may form the accommodating space 140 to accommodate at least a portion of the connecting arms 222a and 222b of the razor handle 200. The connector 130 has a first side facing the docking portion 150 to form an inlet of the accommodating space 140, and a second side connected to the lower surface of the blade housing 120 to close the accommodating space 140.

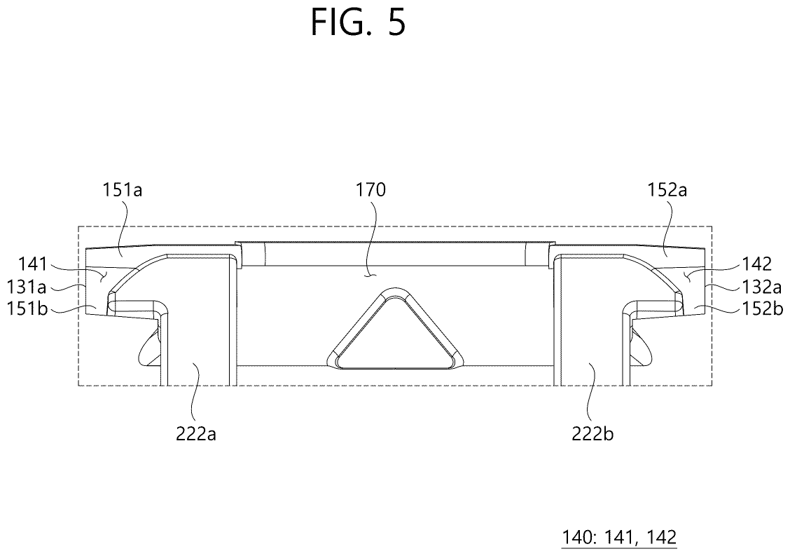

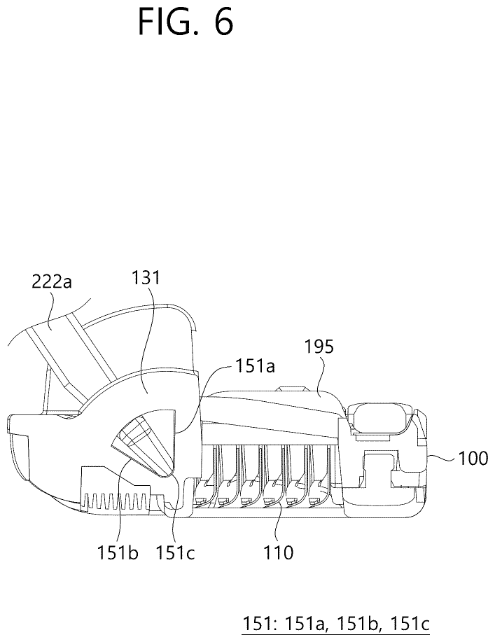

FIG. 5 is a bottom view illustrating that the connecting arm of FIG. 2 is accommodated in a connector. FIG. 6 is a lateral cross-sectional view illustrating that the connecting arm of FIG. 2 is accommodated in the connector.

Referring to FIGS. 5 and 6, when the connecting arms 222a and 222b are accommodated in the accommodating space 140, the connecting arms 222a and 222b are pivotable within the accommodating space 140, and the inner surface of the connector 130 may be in surface-contact with the connecting arms 222a and 222b. The inner surface of the connector 130 refers to a portion that forms the accommodating space 140 together with the docking portion 150 and the closing surfaces 131a and 132a. The inner surface of the connector 130 to be in surface-contact with the connecting arms 222a and 222b refers to a surface that faces opposite connecting surfaces 151c and 152c of the docking portion 150 (to be described later). A portion of the connecting arms 222a and 222b to be in surface-contact with the inner surface of the connector 130 may be a surface facing the razor handle 200. The inner surface of the connector 130 and the surface of the connecting arms 222a and 222b may be in surface-contact with each other partially rather than entirely. As the inner surface of the connector 130 and the surface of the connecting arms 222a and 222b are partially in surface-contact with each other, the pivoting operation of the razor cartridge 100 may be smoothly performed.

According to an embodiment of the disclosure, a plurality of connectors 130 may be formed. For example, the connector 130 may include a first connector 131 and a second connector 132. The first connector 131 and the second connector 132 may be disposed on the lower surface of the blade housing 120 and face each other while being spaced apart in the longitudinal direction.

The first connector 131 may be disposed on a first side of the lower surface of the blade housing 120, and the second connector 132 may be disposed on a second side of the lower surface of the blade housing 120. A first side of the blade housing 120 refers the left (negative x-axial direction) of the center in FIGS. 2 and 3, and a second side refers to the right (positive x-axial direction) of the center.

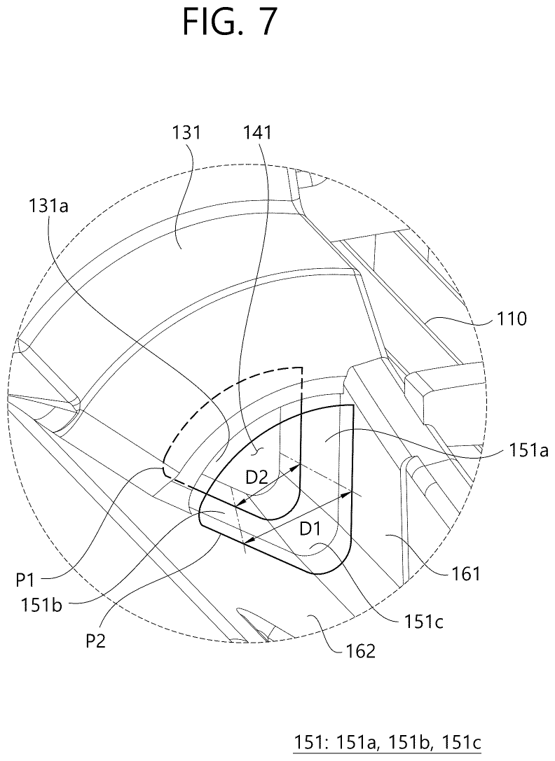

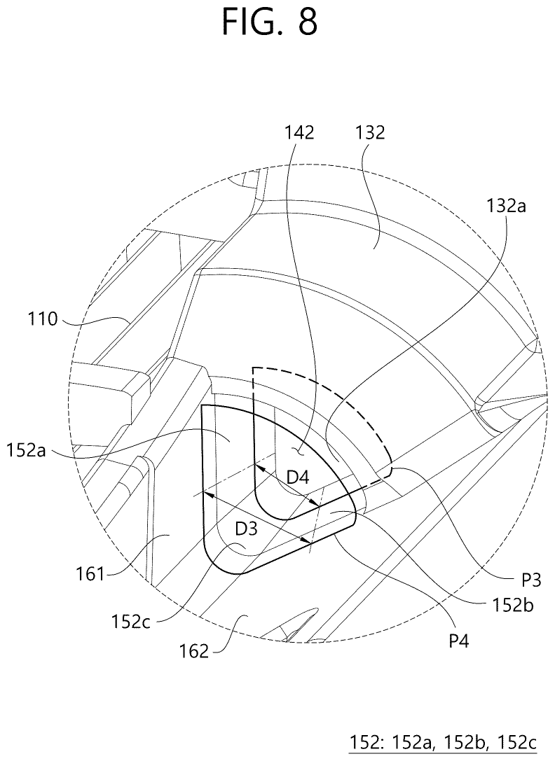

FIG. 7 is a perspective view of an area A of FIG. 3, and FIG. 8 is a perspective view of an area B of FIG. 3.

Referring to FIGS. 7 and 8, the first connector 131 and the second connector 132 may form a first accommodating space 141 and a second accommodating space 142 in which the first connecting arm 222a and the second connecting arm 222b to be described later are accommodated, respectively. The accommodating space 140 may include the first accommodating space 141 and the second accommodating space 142. The first accommodating space 141 and the second accommodating space 142 may be disposed being spaced apart in the longitudinal direction.

Referring to FIG. 7, the first side of the first connector 131 faces a first docking portion 151 to be described later to form the inlet of the first accommodating space 141, and the second side may be connected to the lower surface of the blade housing 120 to close the first accommodating space 141. The lower surface of the blade housing 120 to which the first connector 131 is connected refers to a rear end of a first opposite surface 151a and a rear end of a second opposite surface 151b to be described later.

The first side of the first connector 131 may be opened so that the first connecting arm 222a can enter the first accommodating space 141, and the second side may include a first closing surface 131a connecting the first opposite surface 151a and the second opposite surface 151b. The first closing surface 131a may be formed to face the inlet of the first accommodating space 141 and be substantially parallel to the lateral surface of the blade housing 120. The first closing surface 131a may be connected to the slope of the first docking portion 151 to be described later.

Referring to FIG. 8, the first side of the second connector 132 faces a second docking portion 152 to be described later to form the inlet of the second accommodating space 142, and the second side may be connected to the lower surface of the blade housing 120 to close the second accommodating space 142. The lower surface of the blade housing 120 to which the second connector 132 is connected refers to a rear end of a third opposite surface 152a and a rear end of a fourth opposite surface 152b to be described later.

The first side of the second connector 132 may be opened so that the second connecting arm 222b can enter the second accommodating space 142, and the second side may include a second closing surface 132a connecting the third opposite surface 152a and the fourth opposite surface 152b. The second closing surface 132a may be formed to face the inlet of the second accommodating space 142 and parallel to the lateral surface of the blade housing 120. The second closing surface 132a may be connected to the slope of the second docking portion 152 to be described later.

Referring to FIGS. 3 and 4, the docking portion 150 may constitute a portion of the lower surface of the blade housing 120, and may form the accommodating space 140 together with the connector 130. The docking portion 150 may constitute a portion of the lower surface of the blade housing 120 to form the accommodating space 140 together with the connector 130.

The docking portion 150 may form the inlet of the accommodating space 140, and include a downward slope in the opposite direction to the entry direction in which the connecting arms 222a and 222b enter the accommodating space 140.

Referring to FIGS. 7 and 8, the slope of the docking portion 150 may be downward in the opposite direction to the entry direction of the connecting arms 222a and 222b. The slope of the docking portion 150 may be connected to the closing surfaces 131a and 132a of the connector 130.

The slope of the docking portion 150 may allow the connecting arms 222a and 222b accommodated in the accommodating space 140 to be easily separated in the opposite direction to the entry direction when the razor cartridge 100 is replaced. When the connecting arms 222a and 222b are moved in the opposite direction to the entry direction to replace the razor cartridge 100, the slope of the docking portion 150 minimizes the friction by reducing the contact area between the connecting arms 222a and 222b and the docking portion 150, thereby allowing the connecting arms 222a and 222b to be easily separated from the accommodating space 140. Accordingly, a user can separate the razor cartridge 100 from the razor handle 200 without much effort.

Referring to FIGS. 7 and 8, a plurality of docking portions 150 may be formed according to an embodiment of the disclosure. The docking portion 150 may include a first docking portion 151 and a second docking portion 152. The first docking portion 151 and the second docking portion 152 may constitute a portion of the lower surface of the blade housing 120.

Referring to FIG. 7, the first docking portion 151 may be formed on the first side of the blade housing 120, so as to form the first accommodating space 141 together with the first connector 131. The first docking portion 151 may form the entrance to the first accommodating space 141. The first docking portion 151 may include the first opposite surface 151a and the second opposite surface 151b, and may form the first accommodating space 141. The first opposite surface 151a and the second opposite surface 151b are connected to the first closing surface 131a of the connector 130 and close the first accommodating space 141. The first opposite surface 151a may be disposed closer to the blade 110 than the second opposite surface 151b.

At least one of the first opposite surface 151a and the second opposite surface 151b may include a downward slope in the opposite direction to the entry direction of the first connecting arm 222a. The first opposite surface 151a may form a downward slope toward a first entry surface 161 (to be described later), and the second opposite surface 151b may form a downward slope toward a second entry surface 162 (to be described later). In other words, the first docking portion 151 may form a downward slope toward the second docking portion 152.

Further, the first opposite surface 151a may extend from the first entry surface 161, and the second opposite surface 151b may extend from the second entry surface 162. The first opposite surface 151a and the second opposite surface 151b may be connected to the first closing surface 131a of the connector 130 and close the first accommodating space 141.

The first opposite surface 151a and the second opposite surface 151b may form a predetermined angle with each other. An angle formed between the first opposite surface 151a and the second opposite surface 151b may limit the pivoting angle of the first connecting arm 222a. An angle formed between the first opposite surface 151a and the second opposite surface 151b may range from 45° to 70°, and in this case, a pivoting angle of the first connecting arm 222a may range from 30° to 50°. Preferably, an angle formed between the first opposite surface 151a and the second opposite surface 151b may range from 50° to 65°, and in this case, a pivoting angle of the first connecting arm 222a may range from 35° to 45°.

In the first docking portion 151, the cross-sectional area of the first accommodating space 141 may be formed to gradually decrease from the inlet of the first accommodating space 141 toward the first closing surface 131a. The cross-sectional area refers to the area of a surface perpendicular to the longitudinal direction. A cross-sectional area P1 of the first accommodating space 141 close to the first closing surface 131a may be smaller than a cross-sectional area P2 of the first accommodating space 141 close to the inlet of the first accommodating space 141.

Further, the first docking portion 151 may further include a first opposite connecting surface 151c connecting a front end of the first opposite surface 151a and a front end of the second opposite surface 151b. The first opposite connecting surface 151c may be formed on the first side of the lower surface of the blade housing 120 to connect the front end of the first opposite surface 151a and the front end of the second opposite surface 151b. The first opposite connecting surface 151c may include a downward slope in the opposite direction to the entry direction of the first connecting arm 222a.

Like the slopes of the first opposite surface 151a and the second opposite surface 151b, the slope of the first opposite connecting surface 151c may allow the first connecting arm 222a accommodated in the first accommodating space 141 to be easily separated in the opposite direction to the entry direction when the razor cartridge 100 is replaced.

A distance between the first opposite surface 151a and the second opposite surface 151b may become narrow gradually along the entry direction of the first connecting arm 222a. The distance between the first opposite surface 151a and the second opposite surface 151b may refer to a distance between a virtual longitudinal line on the first opposite surface 151a extending from the inlet of the first accommodating space 141 toward the first closing surface 131a and a virtual longitudinal line on the second opposite surface 151b extending from the inlet of the first accommodating space 141 toward the first closing surface 131a.

The downward slope provided in at least one of the first opposite surface 151a and the second opposite surface 151b may make the distance between the first opposite surface 151a and the second opposite surface 151b narrow along the entry direction of the first connecting arm 222a. When comparing a distance D1 between the first opposite surface 151a and the second opposite surface 151b close to the inlet of the first accommodating space 141 and a distance D2 between the first opposite surface 151a and the second opposite surface 151b close to the first closing surface 131a, the distance D2 between the first opposite surface 151a and the second opposite surface 151b close to the first closing surface 131a may be narrower than the distance D1 between the first opposite surface 151a and the second opposite surface 151b close to the inlet of the first accommodating space 141.

As the distance between the first opposite surface 151a and the second opposite surface 151b gradually increases along the opposite direction to the entry direction of the first connecting arm 222a, the first connecting arm 222a is easily separated from the first accommodating space 141. As the first connecting arm 222a is easily separated from the first accommodating space 141, a user can replace the razor cartridge 100 with a new one without much effort.

Referring to FIG. 6, when the first connecting arm 222a is accommodated in the first accommodating space 141, the first opposite connecting surface 151c may be in line-contact or point-contact with the first connecting arm 222a. A portion of the first connecting arm 222a to be in line-contact or point-contact with the first opposite connecting surface 151c may be a portion of the surface facing the first opposite surface 151a. As the first connecting arm 222a is in line-contact or point-contact with the first opposite connecting surface 151c partially rather than entirely, the contact area between the first opposite connecting surface 151c and the first connecting arm 222a may be reduced. By reducing the contact area between the first opposition connecting surface 151c and the first connecting arm 222a to minimize the friction, the razor cartridge 100 may pivot smoothly.

Referring to FIG. 8, the second docking portion 152 may be formed on the second side of the lower surface of the blade housing 120, so as to form the second accommodating space 142 together with the second connector 132. The second docking portion 152 may form the entrance to the second accommodating space 142. The second docking portion 152 may include a third opposite surface 152a and a fourth opposite surface 152b, and may form the second accommodating space 142. The third opposite surface 152a and the fourth opposite surface 152b are connected to the second closing surface 132a of the connector 130 and close the second accommodating space 142. The third opposite surface 152a may be disposed closer to the blade 110 than the fourth opposite surface 152b.

At least one of the third opposite surface 152a and the fourth opposite surface 152b may include a downward slope in the opposite direction to the entry direction of the second connecting arm 222b. The third opposite surface 152a may form a downward slope toward the first entry surface 161 (to be described later), and the fourth opposite surface 152b may form a downward slope toward the second entry surface 162 (to be described later). In other words, the second docking portion 152 may form a downward slope toward the first docking portion 151.

Further, the third opposite surface 152a may extend from the first entry surface 161, and the fourth opposite surface 152b may extend from the second entry surface 162. The third opposite surface 152a and the fourth opposite surface 152b may be connected to the second closing surface 132a of the connector 130 and close the second accommodating space 142.

The third opposite surface 152a and the fourth opposite surface 152b may form a predetermined angle with each other. An angle formed between the third opposite surface 152a and the fourth opposite surface 152b may limit the pivoting angle of the second connecting arm 222b. An angle formed between the third opposite surface 152a and the fourth opposite surface 152b may range from 45° to 70°, and in this case, a pivoting angle of the second connecting arm 222b may range from 30° to 50°. Preferably, an angle formed between the third opposite surface 152a and the fourth opposite surface 152b may range from 50° to 65°, and in this case, a pivoting angle of the second connecting arm 222b may range from 35° to 45°.

In the second docking portion 152, the cross-sectional area of the second accommodating space 142 gradually decreases from the inlet of the second accommodating space 142 toward the second closing surface 132a. The cross-sectional area refers to the area of a surface perpendicular to the longitudinal direction. A cross-sectional area P3 of the second accommodating space 142 close to the second closing surface 132a may be smaller than a cross-sectional area P4 of the second accommodating space 142 close to the inlet of the second accommodating space 142.

Further, the second docking portion 152 may include a second opposite connecting surface 152c connecting a front end of the third opposite surface 152a and a front end of the fourth opposite surface 152b. The second opposite connecting surface 152c may be formed on the second side of the lower surface of the blade housing 120 to connect the front end of the third opposite surface 152a and the front end of the fourth opposite surface 152b. The second opposite connecting surface 152c may include a downward slope in the opposite direction to the entry direction of the second connecting arm 222b.

Like the slope of the first opposite connecting surface 151c, the slope of the second opposite connecting surface 152c may allow the second connecting arm 222b accommodated in the second accommodating space 142 to be easily separated in the opposite direction to the entry direction when the razor cartridge 100 is replaced.

A distance between the third opposite surface 152a and the fourth opposite surface 152b may become narrow gradually along the entry direction of the second connecting arm 222b. The distance between the third opposite surface 152a and the fourth opposite surface 152b may refer to a distance between a virtual longitudinal line on the third opposite surface 152a extending from the inlet of the second accommodating space 142 toward the second closing surface 132a and a virtual longitudinal line on the fourth opposite surface 152b extending from the inlet of the second accommodating space 142 toward the second closing surface 132a.

The downward slope provided in at least one of the third opposite surface 152a and the fourth opposite surface 152b may make the distance between the third opposite surface 152a and the fourth opposite surface 152b narrow along the entry direction of the second connecting arm 222b. When comparing a distance D3 between the third opposite surface 152a and the fourth opposite surface 152b close to the inlet of the second accommodating space 142 and a distance D4 between the third opposite surface 152a and the fourth opposite surface 152b close to the second closing surface 132a, the distance D4 between the third opposite surface 152a and the fourth opposite surface 152b close to the second closing surface 132a may be narrower than the distance D3 between the third opposite surface 152a and the fourth opposite surface 152b close to the inlet of the second accommodating space 142.

As the distance between the third opposite surface 152a and the fourth opposite surface 152b gradually increases along the opposite direction to the entry direction of the second connecting arm 222b, the second connecting arm 222b is easily separated from the second accommodating space 142. As the second connecting arm 222b is easily separated from the second accommodating space 142, a user can replace the razor cartridge 100 with a new one without much effort.

When the second connecting arm 222b is accommodated in the second accelerating space 142, the second opposite connecting surface 152c may be in line-contact or point-contact with the second connecting arm 222b. Like the line-contact or point-contact between the first opposite connecting surface 151c and the first connecting arm 222a, the second opposite connecting surface 152c and the second connecting arm 222b are in line-contact or point-contact with each other, thereby making the razor cartridge 100 pivot smoothly.

Referring to FIG. 3, the entry portion 160, which forms an entry space 170 for the connecting arms 222a and 222b, may be provided between the first docking portion 151 and the second docking portion 152. The entry portion 160 may form a portion of the lower surface of the blade housing 120.

The entry portion 160 may be connected to the first docking portion 151 and the second docking portion 152, and include the first entry surface 161 and the second entry surface 162. The first entry surface 161 and the second entry surface 162 may face each other.

The first entry surface 161 may be positioned rearward of the second entry surface 162 on the lower surface of the blade housing 120, and may be connected to the first opposite surface 151a and the third opposite surface 152a. The first opposite surface 151a and the third opposite surface 152a may extend away from each other from the first entry surface 161 and may be connected to the first entry surface 161. The first entry surface 161 may constitute at least a portion of one surface of the rinsing frame 181 (to be described later).

The second entry surface 162 may be positioned forward of the first entry surface 161, and may be connected to the second opposite surface 151b and the fourth opposite surface 152b. The second opposite surface 151b and the fourth opposite surface 152b may extend away from each other from the second entry surface 162 and may be connected to the second entry surface 162. The second entry surface 162 may constitute at least a portion of the rear surface of the guard seating portion 191 (to be described later).

To couple the razor cartridge 100 and the razor handle 200, the first connecting arm 222a and the second connecting arm 222b may enter the entry space 170 along the first direction. The first direction refers to a direction from a handle head 220 toward the razor cartridge 100. The second entry surface 162 may allow the first connecting arm 222a and the second connecting arm 222b to be guided into the entry space 170 along the first direction. When the first connecting arm 222a and the second connecting arm 222b enter the second entry surface 162, the second entry surface 162 may be in contact with the first connecting arm 222a and the second connecting arm 222b, and guide the first connecting arm 222a and the second connecting arm 222b to the entry space 170.

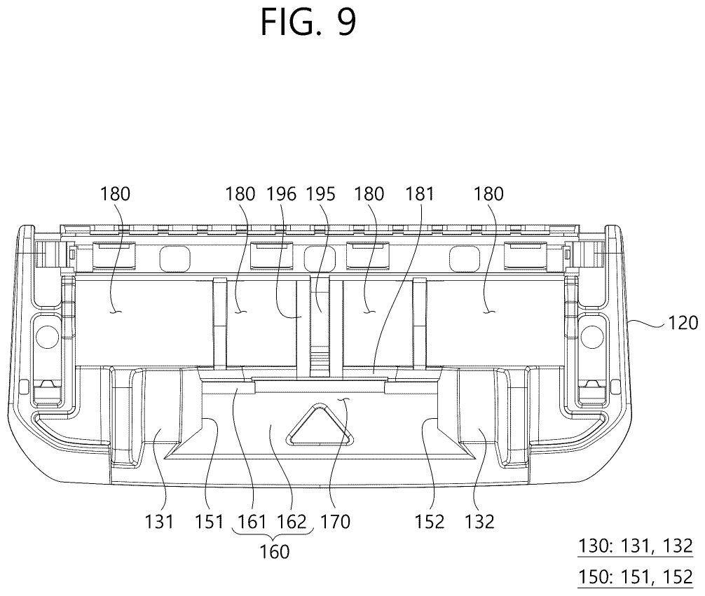

FIG. 9 is a bottom view of a blade housing of FIG. 2.

Referring to FIG. 9, the rinsing opening 180 refer to an area through which residues after shaving, such as shaving cream and cut body hair, are discharged, and may be formed penetrating the blade housing 120 up and down. The rinsing opening 180 refers to an area through which washing water for washing the shaving residues are discharged to the outside along with the shaving residues. As the connector 130 is disposed closer to the front of the blade housing 120 than the rinsing opening 180, the rinsing opening 180 may not be covered with the plunger 223a or a plunger housing 223b (to be described later). Further, the pivot axis of the razor cartridge 100 according to the disclosure is located forward of the frontmost blade 110, and it is advantageous to form the rinsing opening 180 not to be covered with the plunger 223a or the plunger housing 223b.

The rinsing frame 181 forms a boundary of the rinsing opening 180, and one surface of the rinsing frame 181 may include the first entry surface 161. With the rinsing frame 181 as the boundary, the docking portion 150, the connector 130, and the entry portion 160 may be disposed at the front, and the rinsing opening 180 and the blade 110 may be disposed at the rear.

FIG. 10 is a plan view of a blade housing of FIG. 2.

Referring to FIG. 10, the guard seating portion 191 may be provided in front of an upper surface of the blade housing 120 so that the guard 190 can be seated thereon. Preferably, the guard seating portion 191 may be provided in the form of a groove to prevent the guard 190 from moving while being seated thereon. The depth of the guard seating portion 191 may be smaller than or equal to the thickness of the guard 190.

Referring to FIG. 9, the rear surface of the guard seating portion 191 may constitute the second entry surface 162. The guard seating portion 191 may be formed from the first side to the second side in the longitudinal direction in front of the upper surface of the blade housing 120. Therefore, the rear surface of the guard seating portion 191 is wider than in the longitudinal direction than the second entry surface 162 formed between the first docking portion 151 and the second docking portion 152, and thus the second entry surface 162 may constitute at least a portion of the rear surface of the guard seating portion 191.

FIG. 11 is a plan view of the razor cartridge of FIG. 2.

Referring to FIG. 11, the guard 190 may be provided in front of the upper surface of the blade housing 120 to be positioned in front of the cutting edge of the blade 110. During a shaving process, the guard 190 comes into close contact with a user's skin and pulls the skin to improve a shaving effect of the blade 110. To more effectively pull the skin of a user, the guard 190 may have an embossed or engraved pattern on the upper surface thereof. The upper surface of the guard 190 may be formed of a material such as rubber or silicone to provide a soft contact feeling to a user.

Referring to FIG. 11, the clips 193 may be formed on the opposite sides of the blade housing 120 to extend in the transverse direction and prevent the plurality of blades 110 from being separated from the blade housing 120. The clips 193 may be provided on both sides of the blade housing 120 to cover portions of both respective ends of the blade 110 while the blade 110 is accommodated in the blade housing 120.

Referring to FIG. 11, the cap 194 may be provided in rear of the upper surface of the blade housing 120. The cap 194 may include a lubrication band exposed to the upper surface of the blade housing 120. The lubrication band includes a lubricating material, and applies the lubricating material to a skin surface where the blade 110 has passed during the shaving process. The lubricating material may include ingredients to protect the skin after shaving.

Referring to FIG. 9, the cam surface 195 is in contact with the plumber 223a to limit a pivoting motion of the razor cartridge 100, and may protrude from a bridge 196 formed along the transverse direction of the blade housing 120. The bridge 196 refers to a portion that supports the blades 110 accommodated in the blade housing 120.

Below, the razor handle 200 to which the razor cartridge 100 is detachably coupled according to an embodiment of the disclosure will be described.

Referring to FIG. 1, the razor handle 200 may include a handle body 210, and the handle head 220.

The handle body 210 forms the body of the razor handle 200 and refers to a portion to be held by a user.

The handle head 220 is provided at a first end of the handle body 210, is detachably coupled to the razor cartridge 100, and pivotally supports the coupled razor cartridge 100.

The handle head 220 is detachably coupled to the connector 130 of the razor cartridge 100, and pivotally supports the razor cartridge 100 within a certain angle range with respect to the pivot axis. For example, the handle head 220 may support the razor cartridge 100 to pivot within a range of 90 degrees or less from a neutral position. The neutral position refers to a state where no external force is applied in the state that the handle head 220 and the razor cartridge 100 are coupled.

Referring to FIG. 2, the handle head 220 may include an operating portion 221, a coupling portion 222, and a restoring force provider 223.

The operating portion 221 may be used to separate the razor cartridge 100 from the razor handle 200 by operating the coupling portion 222 in the state that the razor cartridge 100 and the razor handle 200 are coupled. When the operating portion 221 is moved in the first direction by a user, a distance between the end portions of the first connecting arm 222a and the second connecting arm 222b becomes narrow, and the first connecting arm 222a and the second connecting arm 222b are separated from the first accommodating space 141 and the second accommodating space 142. The first direction refers to a direction from the handle head 220 toward the razor cartridge 100.

The coupling portion 222 is detachably coupled to the connector 130 of the razor cartridge 100, and may include the connecting arms 222a and 222b spaced apart from each other in the longitudinal direction. The connecting arms 222a and 222b may include the first connecting arm 222a and the second connecting arm 222b.

Referring to FIG. 5, the first connecting arm 222a and the second connecting arm 222b may be accommodated in the first accommodating space 141 and the second accommodating space 142 as the first end portions thereof enter the first accommodating space 141 and the second accommodating space 142. The first end portion of the first connecting arm 222a and the first end portion of the second connecting arm 222b refer to portions facing the first closing surface 131a and the second closing surface 132a, respectively.

The first connecting arm 222a and the second connecting arm 222b may be elastically supported by an elastic member (not shown) so that the distance between the end portions thereof can vary.

When the operating portion 221 is moved in the first direction by a user, the distance between the end portions of the first connecting arm 222a and the second connecting arm 222b may become narrow. When the operating portion 221 returns to its original position in the opposite direction to the first direction, the first connecting arm 222a and the second connecting arm 222b are elastically supported by the elastic member, and thus the distance between the first connecting arm 222a and the second connecting arm 222b are restored to its original state.

FIG. 2 and the like show that the coupling portion 222 includes the first connecting arm 222a and the second connecting arm 222b, but the coupling portion 222 according to the disclosure is not limited thereto and may be implemented in various detachable structures such as a latch coupling method, a hook coupling method, a snap-fit coupling method, a boss coupling method, and a coupling method based on a magnetic force.

Referring to FIG. 2, the restoring force providing portion 223 provides a restoring force to the razor cartridge 100 pivotable around the razor handle 200 within a certain angle range, and may include the plunger 223a, the plunger housing 223b, and the elastic member (not shown).

The plunger 223a provides the restoring force to the razor cartridge 100, and may elastically support the razor cartridge 100. The plunger 223a is supported by the elastic member, thereby providing the restoring force to restore the razor cartridge 100 pivoted around the pivot axis to the neutral position.

The plunger housing 223b supports the plunger 223a to slide, and may form a space in which the plunger 223a and the elastic member are accommodated. The plunger housing 223b may include the upper housing (not shown) and the lower housing (not shown). The upper housing and the lower housing may be coupled. By coupling the upper housing and the lower housing, a space to accommodate the plunger 223a and the elastic member therein may be formed. The upper housing serves to cover the accommodating space, and the lower housing may include a guide portion (not shown) that guides the plunger 223a to slide.

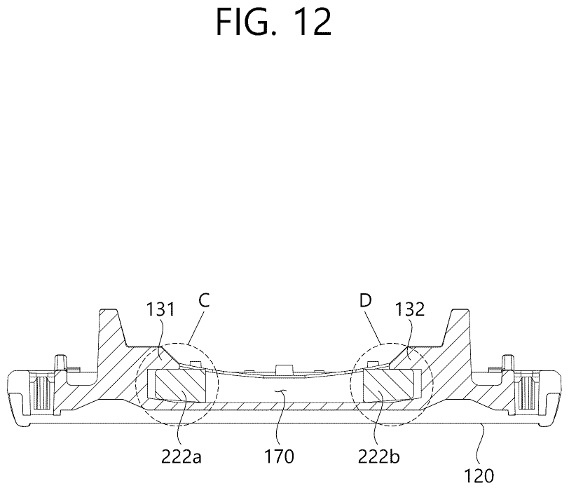

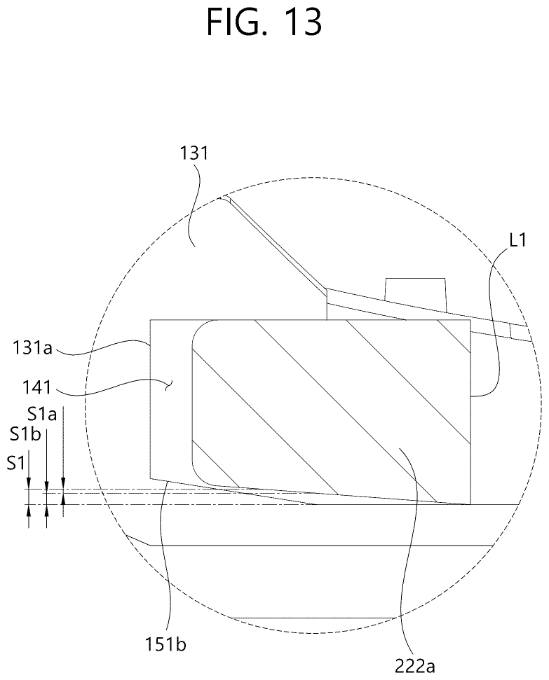

FIG. 12 is a cross-sectional view taken along the line XII-XII′ of FIG. 2, and FIG. 13 is an enlarged view of an area C of FIG. 12.

Referring to FIGS. 12 and 13, when the razor cartridge 100 is in the neutral position with respect to the razor handle 200, at least a portion of one surface of the first connecting arm 222a may be formed to form a first space S1 from the second opposite surface 151b. One surface of the first connecting arm 222a with which the first space S1 is formed refers to a surface facing the second opposite surface 161b when the razor cartridge 100 is in the neutral position.

Likewise, when the razor cartridge 100 is in the neutral position with respect to the razor handle 200, at least a portion of one surface of the second connecting arm 222b may be formed to form a second space S2 from the fourth opposite surface 152b. One surface of the second connecting arm 222b with which the second space S2 is formed refers to a surface facing the fourth opposite surface 152b when the razor cartridge 100 is in the neutral position.

When the razor cartridge 100 is pivoted, the first space S1 and the second space S2 serve to reduce friction caused by contact between the first connecting arm 222a and the second opposite surface 151b and friction caused by contact between the second connecting arm 222b and the fourth opposite surface 152b. The first space S1 decreases the contact area between the first connecting arm 222a and the second opposite surface 151b, and the second space S2 decreases the contact area between the second connecting arm 222b and the second opposite surface 151b. As the friction is reduced, the resistance of the razor cartridge 100 to the pivoting is reduced, thereby allowing the razor cartridge 100 to smoothly pivot during a razor stroke.

When replacing the razor cartridge 100, the first connecting arm 222a and the second connecting arm 222b are moved in the opposite direction to the entry direction, and thus separated from the first accommodating space 141 and the second accommodating space 142, respectively. When the friction acting in the entry direction is reduced for the end portions of the first connecting arm 222a and the second connecting arm 222b moving in the opposite direction to the entry direction, the first connecting arm 222a and the second connecting arm 222b are easily separated from the first accommodating space 141 and the second accommodating space 142, respectively. Accordingly, the first space S1 and the second space S2 make it easy to separate the razor cartridge 100 from the razor handle 200.

In addition, the end portion of the first connecting arm 222a may include a first edge L1 facing the end portion of the second connecting arm 222b. The end portion of the second connecting arm 222b may include a second edge L2 facing the end portion of the first connecting arm 222a. The first edge L1 refers to an edge located on the second side opposite to the first end portion of the first connecting arm 222a, and the second edge L2 refers to an edge located on the second side opposite to the first end portion of the second connecting arm 222b.

Further, one surface of the first connecting arm 222a may be formed so that the first space S1 can decrease from the first edge L1 to the first end portion of the first connecting arm 222a. Referring to FIG. 13, the first space S1a close to the first end portion of the first connecting arm 222a may decrease more than the first space S1b close to the first edge L1. In this case, even though the first docking portion 151 has no downward slope, the first connecting arm 222a may be easily separated from the first accommodating space 141 and the second accommodating space 142. Further, when the first docking portion 151 includes a downward slope, the slope of one surface of the first connecting arm 222a for the shaving plane may be less than the downward slope of the second opposite surface 151b for the shaving plane. Accordingly, the first connecting arm 222a may be easily separated from the first accommodating space 141.

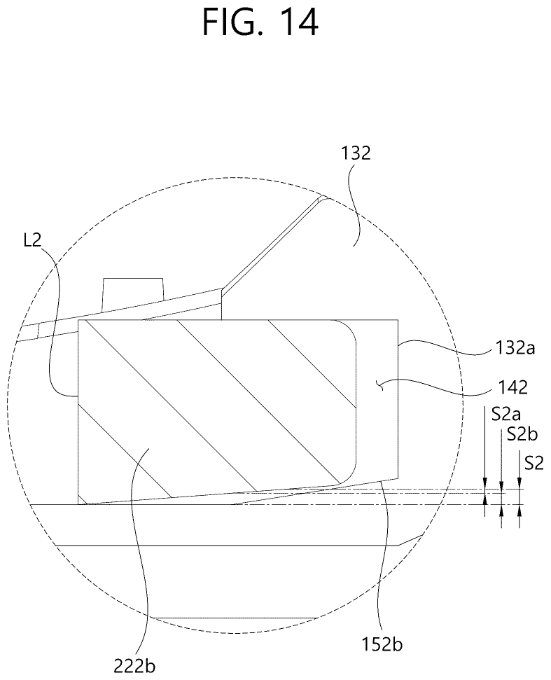

FIG. 14 is an enlarged view of an area D of FIG. 12.

Referring to FIG. 14, similarly to the first connecting arm 222a, one surface of the second connecting arm 222b may be formed so that the second space S2 can decrease from the second edge L2 to the first end portion of the second connecting arm 222b. The second space S2a close to the first end portion of the second connecting arm 222b may decrease more than the second space S2b close to the second edge L2. In this case, even though the second docking portion 152 has no downward slope, the second connecting arm 222b may be easily separated from the second accommodating space 142. Further, when the second docking portion 152 includes a downward slope, the slope of one surface of the second connecting arm 222b for the shaving plane may be less than the downward slope of the fourth opposite surface 152b for the shaving plane. Accordingly, the second connecting arm 222b may be easily separated from the second accommodating space 142.

Meanwhile, a razor assembly 10 may be provided according to another embodiment of the disclosure. Referring to FIG. 1, the razor assembly 10 according to this embodiment of the disclosure may include the razor cartridge 100 and the razor handle 200. The razor cartridge 100 and the razor handle 200 included in the razor assembly 10 according to the disclosure are the same as the razor cartridge 100 and the razor handle 200 described above, and thus repetitive descriptions thereof will be avoided.

Although exemplary embodiments of the disclosure have been described with reference to the accompanying drawings, the configurations described in the embodiments and depicted in the drawings are merely the most preferred embodiments of the disclosure and do not represent all the technical ideas of the disclosure, and thus it should be understood that there may be various equivalents and variations capable of replacing the embodiments at the time of this application. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor cartridge to couple with a razor handle, comprising:
at least one blade formed with a cutting edge; and
a blade housing accommodating the blade in a longitudinal direction to expose the cutting edge toward a front upper side,
wherein the blade housing comprises:
a connector disposed on a lower surface of the blade housing and forming an accommodating space in which a connecting arm of the razor handle is at least partially accommodated; and
a docking portion forming an inlet of the accommodating space on the lower surface of the blade housing and comprising a downward slope in an opposite direction to a direction in which the connecting arm enters the accommodating space.

2. The razor cartridge of claim 1, wherein:
the docking portion comprises a first opposite surface and a second opposite surface facing each other, and
the connector connects a rear end of the first opposite surface and a rear end of the second opposite surface spaced apart from each other.

3. The razor cartridge of claim 2, wherein:
the docking portion further comprises an opposite connecting surface connecting a front end of the first opposite surface and a front end of the second opposite surface and comprising a downward slope in the opposite direction to an entry direction of the connecting arm, and
the opposite connecting surface is in line-contact or point-contact with a portion of a surface of the connecting arm facing the first opposite surface, when the connecting arm is accommodated in the accommodating space.

4. The razor cartridge of claim 3, wherein an inner surface of the connector facing the opposite connecting surface is in surface-contact with a portion of a surface of the connecting arm facing the razor handle, upon accommodating the connecting arm in the accommodating space.

5. The razor cartridge of claim 1, wherein the connector comprises a first side facing the docking portion and forming the inlet of the accommodating space, and a second side connected to the lower surface of the blade housing and closing the accommodating space.

6. The razor cartridge of claim 4, wherein:
the second side of the connector comprises a closing surface connected to the slope of the docking portion, and
the closing surface is formed to face the inlet of the accommodating space and is parallel to a lateral surface of the blade housing.

7. The razor cartridge of claim 2, wherein a distance between the first opposite surface and the second opposite surface becomes narrow gradually along an entry direction of the connecting arm.

8. The razor cartridge of claim 1, wherein:
the accommodating space comprises a first accommodating space and a second accommodating space spaced apart in a longitudinal direction,
the connector comprises a first connector to form the first accommodating space and a second connector to form the second accommodating space,
the docking portion comprises a first docking portion to form an inlet of the first accommodating space and a second docking portion to form an inlet of the second accommodating space,
the first docking portion comprises a downward slope toward the second docking portion, and
the second docking portion comprises a downward slope toward the first docking portion.

9. The razor cartridge of claim 8, wherein the lower surface of the blade housing further comprises an entry portion provided between the first docking portion and the second docking portion and forming an entry space for the connecting arm.

10. The razor cartridge of claim 9, wherein:
the entry portion comprises a first entry surface and a second entry surface facing each other,
the first docking portion comprises a first opposite surface extending from the first entry surface and a second opposite surface extending from the second entry surface, and
the second docking portion comprises a third opposite surface extending from the first entry surface and a fourth opposite surface extending from the second entry surface.

11. The razor cartridge of claim 10, wherein:
the first opposite surface and the third opposite surface form downward slopes toward the first entry surface, and
the second opposite surface and the fourth opposite surface form downward slopes toward the second entry surface.

12. The razor cartridge of claim 10, wherein the blade housing comprises:
a rinsing opening formed penetrating the blade housing up and down, and allowing the blade to be disposed in the longitudinal direction; and
a rinsing frame forming a boundary of the rinsing opening, and
wherein the first entry surface forms at least a portion of one surface of the rinsing frame.

13. The razor cartridge of claim 10, further comprising a guard provided on an upper surface of the blade housing and located in front of the cutting edge,
wherein the blade housing further comprises a guard seating portion on which the guard is seated, and
wherein the second entry surface forms at least a portion of a rear surface of the guard seating portion.

14. A razor cartridge to couple with a razor handle, comprising:
at least one blade formed with a cutting edge; and
a blade housing accommodating the blade in a longitudinal direction to expose the cutting edge toward a front upper side,
wherein the blade housing comprises:
a connector disposed on a lower surface of the blade housing and forming an accommodating space in which a connecting arm of the razor handle is at least partially accommodated; and
a docking portion forming an inlet of the accommodating space on the lower surface of the blade housing and formed to narrow gradually along a direction in which the connecting arm enters the accommodating space.

15. A razor cartridge to couple with a razor handle, comprising:
at least one blade formed with a cutting edge; and
a blade housing accommodating the blade in a longitudinal direction to expose the cutting edge toward a front upper side,
wherein the blade housing comprises:
a connector disposed on a lower surface of the blade housing and forming an accommodating space in which a connecting arm of the razor handle is at least partially accommodated; and
a docking portion forming an inlet of the accommodating space on the lower surface of the blade housing and formed to decrease a cross-sectional area of the accommodating space along a direction in which the connecting arm enters the accommodating space.

16. A razor assembly with a razor handle and a razor cartridge detachably coupled to the razor handle,
wherein the razor handle comprises a first connecting arm and a second connecting arm spaced apart from each other, the first connecting arm and the second connecting arm being elastically supported to be varied in distance between end portions thereof, and
wherein the razor cartridge comprises:
at least one blade formed with a cutting edge; and
a blade housing accommodating the blade in a longitudinal direction to expose the cutting edge toward a front upper side,
the blade housing comprising:
a first connector disposed on a first side of a lower surface of the blade housing and forming a first accommodating space in which a first side of the first connecting arm is accommodated;
a second connector disposed on a second side of the lower surface of the blade housing and forming a second accommodating space in which a second side of the second connecting arm is accommodated;
a first docking portion forming an inlet of the first accommodating space on the lower surface of the blade housing and comprising a downward slope in an opposite direction to a direction where the first side of the first connecting arm enters the first accommodating space; and
a second docking portion forming an inlet of the second accommodating space on the lower surface of the blade housing and comprising a downward slope in an opposite direction to a direction where the second side of the second connecting arm enters the second accommodating space.

17. The razor assembly of claim 16, wherein:
the first docking portion comprises a first opposite surface and a second opposite surface facing each other, in which the first opposite surface is disposed closer to the blade than the second opposite surface,
the second docking portion comprises a third opposite surface and a fourth opposite surface facing each other, in which the third opposite surface is disposed closer to the blade than the fourth opposite surface,
upon the razor cartridge being in a neutral position with respect to the razor handle,
one surface of the first connecting arm facing the second opposite surface is formed to form a first space from the second opposite surface, and
one surface of the second connecting arm facing the fourth opposite surface is formed to form a second space from the fourth opposite surface.

18. The razor assembly of claim 17, wherein:
an end portion of the first connecting arm comprises a first edge facing an end portion of the second connecting arm,
an end portion of the second connecting arm comprises a second edge facing an end portion of the first connecting arm,
one surface of the first connecting arm is formed to decrease the first space from the first edge toward the first side of the first connecting arm, and
one surface of the second connecting arm is formed to decrease the second space from the second edge toward the first side of the second connecting arm.
